(19) United States
(12) Patent Application Publication
(10) Pub. No.: US 2026/0132660 A1
(43) Pub. Date: May 14, 2026

(54) DOOR HANDLE ASSEMBLY FOR VEHICLE DOOR AND METHOD FOR OPERATING THE SAME

(71) Applicant: ILLINOIS TOOL WORKS INC., Glenview, IL (US)

(72) Inventor: Penghui YI, Shanghai (CN)

(21) Appl. No.: 19/381,279

(22) Filed: Nov. 6, 2025

(30) Foreign Application Priority Data
Nov. 8, 2024 (CN) 2024115950392

(51) Int. Cl. E05B 85/10

(52) U.S. Cl. CPC E05B 85/107

(57) ABSTRACT

The present disclosure provides a door handle assembly for a vehicle door. The vehicle door has a door surface, the door handle assembly includes a handle seat, a handle, a driving device, a handle shaft and a transmission device. The handle has a retracted position and a deployed position. The handle is flush with the door surface when the handle is in the retracted position. The handle protrudes outwardly relative to the door surface when the handle is in the deployed position. The handle shaft is configured to rotate when driven by the driving device. The transmission device connects the handle shaft to the handle and the handle seat, such that the handle can be driven by the handle shaft to move between the retracted position and the deployed position relative to the handle seat in a translational manner. When the handle is in the retracted position or in the deployed position, the driving device is activated in response to the rotation of the handle shaft by a predetermined angle as the operator pushes the handle, so as to deploy or retract the handle or trigger the unlocking of the vehicle door.

### CROSS-REFERENCE TO RELATED APPLICATIONS

The present disclosure claims priority to Chinese Patent Application No. 2024115950392, filed on Nov. 8, 2024, and entitled “Door Handle Assembly For Vehicle Door And Method For Operating The Same”, which is incorporated herein by reference in its entirety.

### TECHNICAL FIELD

The present disclosure relates to a door handle assembly, and in particular to a door handle assembly for a vehicle door, and a method for operating the door handle assembly.

### BACKGROUND

A door handle assembly of a vehicle, for example, an outer door handle assembly, is designed to be grasped by an operator to open a vehicle door, unlock the vehicle door, etc. For this purpose, a handle of the door handle assembly of the vehicle can extend beyond a door surface of the vehicle, such that the operator can grasp the handle for the above operations.

### SUMMARY OF THE DISCLOSURE

The present disclosure generally relates to a door handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a vehicle having a door handle assembly.

FIG. 1B is a front perspective view of the door handle assembly according to an embodiment of the present disclosure.

FIG. 1C is a rear perspective view of the door handle assembly shown in FIG. 1B.

FIG. 1D is a top view of the door handle assembly shown in FIG. 1C, with a handle in a retracted position.

FIG. 1E is a top view of the door handle assembly shown in FIG. 1C, with the handle in a deployed position.

FIG. 1F is a top view of the door handle assembly shown in FIG. 1C, with the handle in an unlocked position.

FIG. 2A is a front exploded view of the door handle assembly shown in FIG. 1B.

FIG. 2B is a rear exploded view of the door handle assembly shown in FIG. 1B.

FIG. 2C is a perspective view, from a first perspective, of an unlocking structure 125 and a door lock connection structure 115 of the door handle assembly, which are assembled together.

FIG. 2D is a perspective view, from a second perspective, of the unlocking structure 125 and the door lock connection structure 115 of the door handle assembly, which are assembled together.

FIG. 3A is a cross-sectional view, taken along a first section line, of the door handle assembly shown in FIG. 1D, with the handle in the retracted position.

FIG. 3B is a cross-sectional view, taken along a second section line, of the door handle assembly shown in FIG. 1D, with the handle in the retracted position.

FIG. 3C is a cross-sectional view of the door handle assembly shown in FIG. 1E, with the handle in the deployed position.

FIG. 3D is a cross-sectional view of the door handle assembly shown in FIG. 1F, with the handle in the unlocked position.

FIG. 4 is a block diagram of elements of the door handle assembly in communication with a control device according to an embodiment of the present disclosure.

FIG. 5 is a flow chart of a method for operating a door handle assembly according to an embodiment of the present disclosure.

FIG. 6 is a block diagram of an embodiment of the control device shown in FIG. 4.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides a door handle assembly for a vehicle door having a door surface. The door handle assembly includes a handle seat, a handle, a driving device, a handle shaft and a transmission device. The handle has a retracted position and a deployed position, wherein the handle is flush with the door surface when the handle is in the retracted position, and the handle protrudes outwardly relative to the door surface when the handle is in the deployed position. The handle shaft is configured to rotate when driven by the driving device. The transmission device connects the handle shaft to the handle and the handle seat, such that the handle can be driven by the handle shaft to move between the retracted position and the deployed position relative to the handle seat. The transmission device moves to rotate the handle shaft when an operator operates the handle. The driving device is configured such that when the handle is in the retracted position or in the deployed position, the driving device is activated in response to the rotation of the handle shaft as the operator operates the handle, so as to deploy or retract the handle.

In some embodiments, the handle shaft is fixedly connected to an output end of the driving device.

In some embodiments, the transmission device includes an X-shaped hinge structure and a transmission member. The X-shaped hinge structure is connected to the handle and the handle seat and configured to rotate about its rotation axis to enable the handle to move relative to the handle seat to be deployed or retracted. The transmission member connects the handle shaft to the X-shaped hinge structure such that the X-shaped hinge structure, under the drive of the driving device, can be driven by the handle shaft to rotate, and the X-shaped hinge structure rotates to drive the handle shaft to rotate when the operator operates the handle.

In some embodiments, the X-shaped hinge structure includes a first push rod and a second push rod. The first push rod includes a first end and a second end, the first end is slidably connected to the handle seat and the second end is pivotably connected to the handle. The second push rod includes a third end and a fourth end, the third end is slidably connected to the handle and the fourth end is pivotably connected to the handle seat, the first push rod and the second push rod rotate about the rotation axis at an intersection. One end of the transmission member is slidably connected to the second push rod, and the other end of the transmission member is fixedly connected to the handle shaft.

In some embodiments, the handle seat includes a first connection groove, and the first push rod is provided with a first connection pin at the first end thereof, the first connection pin is configured to slide within the first connection groove. The handle includes a second connection groove, and the second push rod is provided with a second connection pin at the third end thereof, the second connection pin is configured to slide within the second connection groove. The second push rod includes a third connection groove, and the transmission member is provided with a third connection pin, the third connection pin is configured to slide within the third connection groove.

In some embodiments, the door handle assembly further includes an unlocking structure configured to be driven by the X-shaped hinge structure to rotate so as to unlock the vehicle door.

In some embodiments, the door handle assembly further includes a push-push structure connecting the handle to the handle seat such that pushing by the operator can move the handle from the retracted position to an intermediately deployed position between the retracted position and the deployed position, or move the handle from the intermediately deployed position to the retracted position.

In some embodiments, the handle includes a removable handle cover, and a lock cylinder of the vehicle door is accommodated in the handle, the handle cover is configured to expose the lock cylinder when it is removed.

In some embodiments, the door handle assembly further includes a detection device configured to detect an angle and direction of rotation of the output end of the driving device for activation of the driving device or unlocking of the vehicle door.

In some embodiments, the door handle assembly further includes a control device communicatively connected to the detection device and the driving device. The control device is configured to control the rotation of the driving device in a first rotational direction to deploy the handle, or in a second rotational direction opposite to the first rotational direction to retract the handle, or to control the unlocking of the vehicle door, based on the detected angle and direction of rotation of the driving device.

According to a second aspect of the present disclosure, the present disclosure provides a method for operating a door handle assembly mounted in a vehicle door. The method includes steps of S1, S2, S3.1, S3.2 and S3.3. In the step S1, it is detected whether a handle of the door handle assembly is in a retracted position or a deployed position. In the step S2, it is detected an angle and direction of rotation of an output end of a driving device when an operator operates the handle. In the step S3.1, the driving device is activated to control the movement of the handle to the deployed position when it is detected that the handle is in the retracted position and the output end of the driving device rotates by a first predetermined angle in a first rotational direction. In the step S3.2, the driving device is activated to control the movement of the handle to the retracted position when it is detected that the handle is in the deployed position and the output end of the driving device rotates by a second predetermined angle in the first rotational direction. In the step S3.3, the unlocking of the vehicle door is controlled and the driving device is activated to control the return of the handle to the deployed position when it is detected that the handle is in the deployed position and the output end of the driving device rotates by a third predetermined angle in a second rotational direction opposite to the first rotational direction.

In some embodiments, in the step S3.1, if a locked-rotor signal of the driving device is detected, the driving device controls the return of the handle to the retracted position. In the step S3.2, if the locked-rotor signal of the driving device is detected, the driving device controls the return of the handle to the deployed position.

In some embodiments, the driving device rotates in the first rotational direction to retract the handle and rotates in the second rotational direction to deploy the handle.

According to a third aspect of the present disclosure, the present disclosure provides a door handle assembly for a vehicle door having a door surface. The door handle assembly includes a handle seat, a handle, a handle shaft, an X-shaped hinge structure and a transmission member. The handle has a retracted position and a deployed position, wherein the handle is flush with the door surface when the handle is in the retracted position, and the handle protrudes outwardly relative to the door surface when the handle is in the deployed position. The handle shaft is configured to rotate under the drive of the driving device. The X-shaped hinge structure is connected to the handle and the handle seat and configured to rotate about its rotation axis to enable the handle to move relative to the handle seat to be deployed or retracted. The transmission member connects the handle shaft to the X-shaped hinge structure such that the X-shaped hinge structure, under the drive of the driving device, can be driven by the handle shaft to rotate, and the X-shaped hinge structure rotates to drive the handle shaft to rotate when the operator operates the handle.

In some embodiments, the X-shaped hinge structure includes a first push rod and a second push rod. The first push rod includes a first end and a second end, the first end is slidably connected to the handle seat and the second end is pivotably connected to the handle. The second push rod includes a third end and a fourth end, the third end is slidably connected to the handle and the fourth end is pivotably connected to the handle seat, the first push rod and the second push rod rotate about the rotation axis at an intersection. One end of the transmission member is slidably connected to the second push rod, and the other end of the transmission member is fixedly connected to the handle shaft.

In some embodiments, the handle seat includes a first connection groove, and the first push rod is provided with a first connection pin at the first end thereof, the first connection pin is configured to slide within the first connection groove. The handle includes a second connection groove, and the second push rod is provided with a second connection pin at the third end thereof, the second connection pin is configured to slide within the second connection groove. The second push rod includes a third connection groove, and the transmission member is provided with a third connection pin, the third connection pin is configured to slide within the third connection groove.

In some embodiments, the door handle assembly further includes an unlocking structure configured to be driven by the X-shaped hinge structure to rotate so as to unlock the vehicle door.

In some embodiments, the door handle assembly further includes a push-push structure connecting the handle to the handle seat such that pushing by the operator can move the handle from the retracted position to an intermediately deployed position between the retracted position and the deployed position, or move the handle from the intermediately deployed position to the retracted position.

In some embodiments, the handle includes a removable handle cover, and a lock cylinder of the vehicle door is accommodated in the handle, the handle cover is configured to expose the lock cylinder when it is removed.

In some embodiments, the handle shaft is fixedly connected to an output end of the driving device.

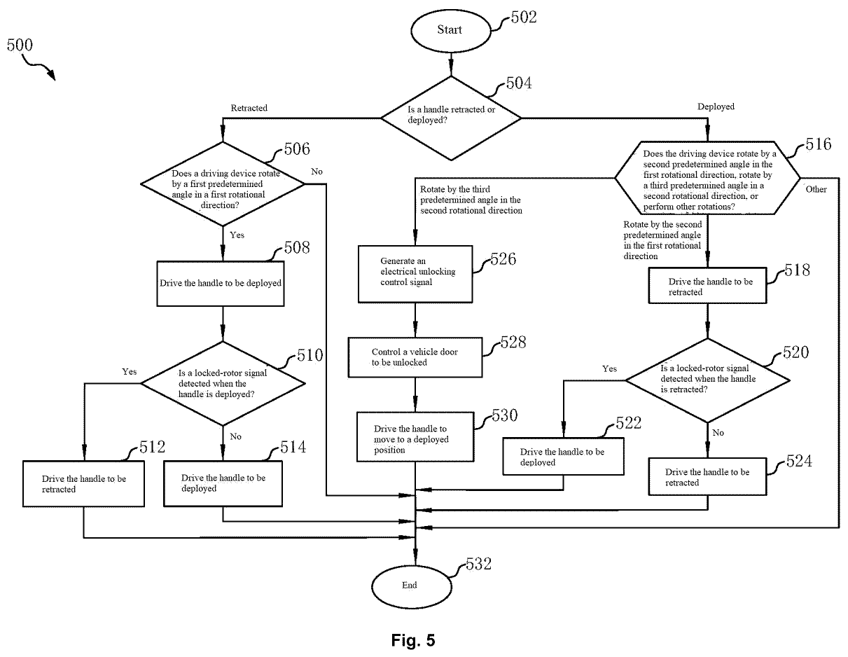

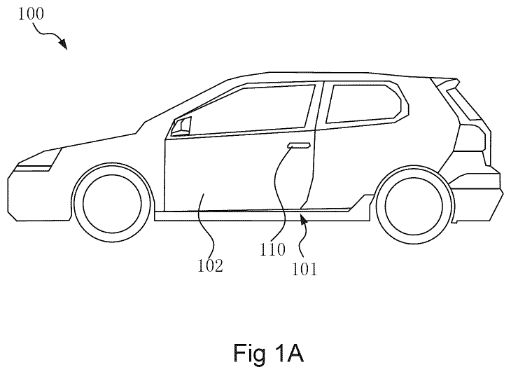

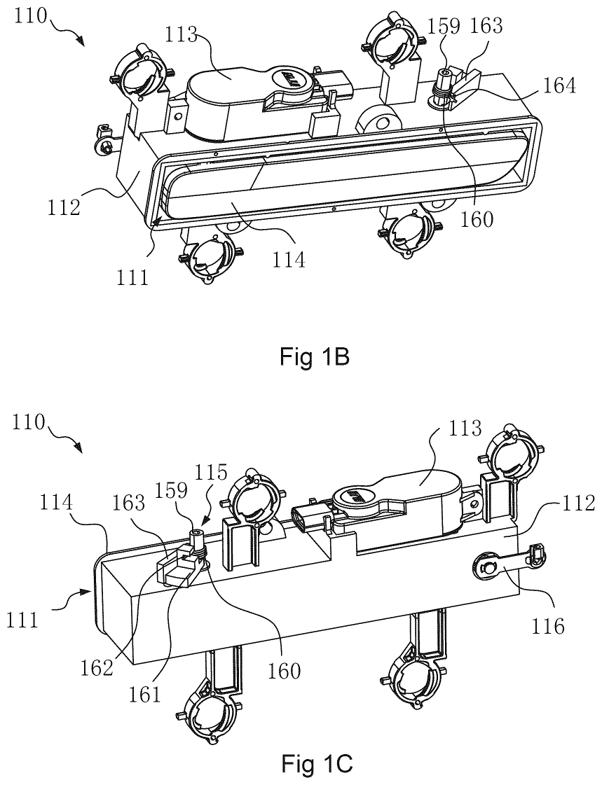

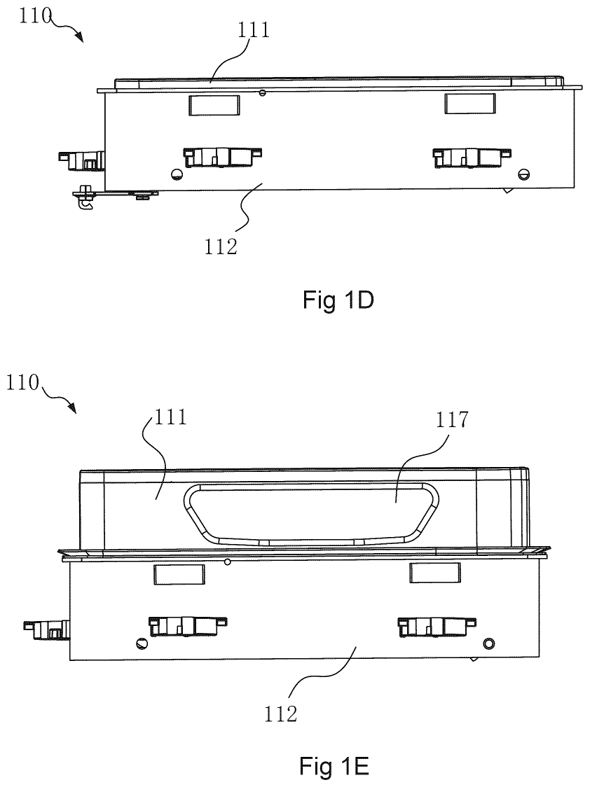

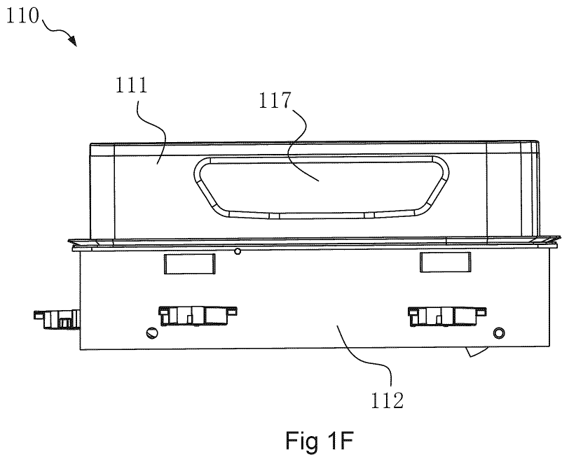

FIG. 1A shows a perspective view of a vehicle 100 having a door handle assembly 110, and FIGS. 1B and 1C show an overall structure of the door handle assembly 110 according to an embodiment of the present disclosure. FIG. 1B is a front perspective view of the door handle assembly 110, and FIG. 1C is a rear perspective view of the door handle assembly 110. FIG. 1D is a top view of the door handle assembly shown in FIG. 1C, with a handle in a retracted position; FIG. 1E is a top view of the door handle assembly shown in FIG. 1C, with the handle in a deployed position; and FIG. 1F is a top view of the door handle assembly shown in FIG. 1C, with the handle in an unlocked position.

As shown in FIG. 1A, the vehicle 100 has a vehicle door 101. The vehicle door 101 has an outer door surface 102. The door handle assembly 110 is a flush door handle assembly that is mounted in the vehicle door 101. The handle 111 (see FIGS. 1B-1F) of the door handle assembly 110 has the retracted position and the deployed position. When the handle 111 is in the retracted position, the handle 111 is flush with the outer door surface 102 of the vehicle, the handle 111 is thus hidden in the vehicle door 101, and an operator cannot pull the handle 111. When the handle 111 is in the deployed position, the handle 111 protrudes outwardly relative to the outer door surface 102 of the vehicle so as to allow the operator to pull the handle 111.

As shown in FIGS. 1B and 1C, the door handle assembly 110 includes the handle 111 and a handle seat 112. The handle seat 112 is mounted into the vehicle door 101. The handle 111 is mounted on the handle seat 112 from a front side of the handle seat 112. The handle 111 is movable relative to the handle seat 112 and thus has the retracted position and the deployed position.

FIGS. 1D and 1E show two states of the handle 111. FIG. 1D is a top view of the door handle assembly 110 with the handle 111 in the retracted position, and FIG. 1E is a top view of the door handle assembly 110 with the handle 111 in the deployed position. As shown in FIG. 1D, when the handle 111 is in the retracted position, the handle 111, except for the portion of the handle flush with the outer door surface 102 of the vehicle, is accommodated in the handle seat 112. As shown in FIG. 1E, the handle 111 is formed with a grip 117. When the handle 111 is in the deployed position, the grip 117 extends out from the handle seat 112, and the operator can thus extend his/her hand into the grip 117 to pull the handle 111.

The handle 111 further includes other positions in addition to the retracted position and the deployed position. For example, as shown in FIG. 1D, when the handle 111 is in the retracted position, the operator presses the handle 111 to move the handle 111 toward the inside of the handle seat 112, so as to reach a deployment trigger position. In the deployment trigger position, a driving device can be triggered to actuate the movement of the handle 111 relative to the handle seat 112 for deployment. When the handle 111 is in the deployment trigger position, the entire handle 111 is accommodated in the handle seat 112, and the handle 111 is recessed inwardly relative to the outer door surface 102 of the vehicle.

Moreover, as shown in FIG. 1E, when the handle 111 is in the deployed position, the operator pulls the handle 111 to move the handle 111 toward the outside of the handle seat 112, so as to reach the unlocked position shown in FIG. 1F. As shown in FIG. 1F, in the unlocked position, the handle 111 is further deployed such that most of the handle is exposed outside the handle seat 112. The handle 111 in this unlocked position can trigger a vehicle door lock to be opened. Moreover, as shown in FIG. 1E, when the handle 111 is in the deployed position, the operator presses the handle 111 to move the handle 111 toward the inside of the handle seat 112, so as to reach a retraction trigger position. In the retraction trigger position, the driving device can be triggered to actuate the movement of the handle 111 relative to the handle seat 112 for retraction.

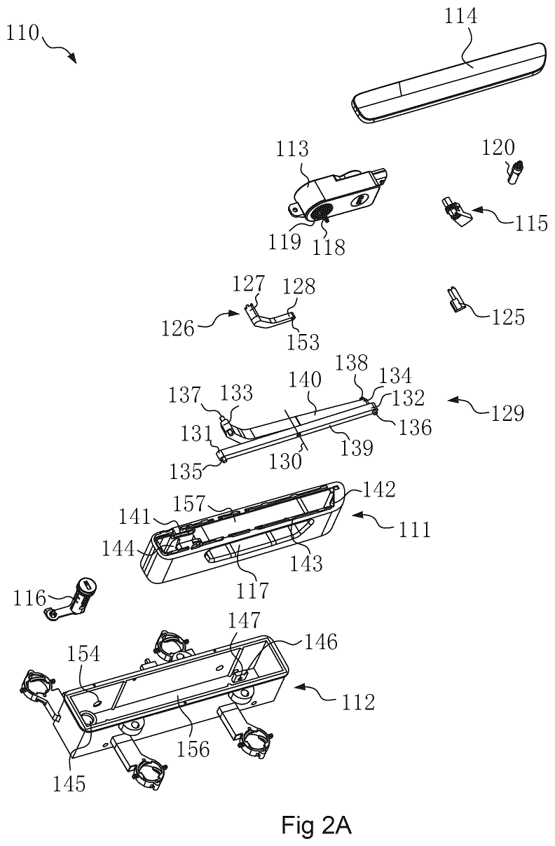

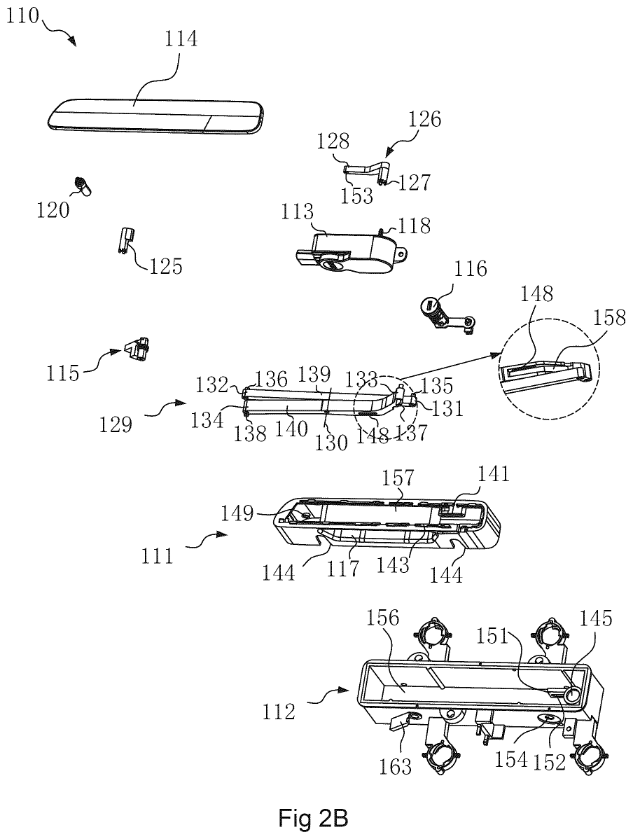

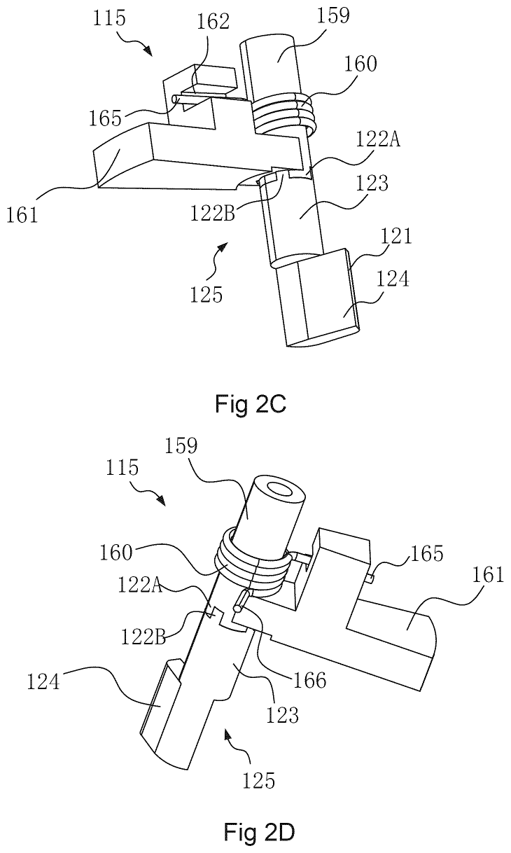

FIGS. 2A and 2B show the detailed structures of the door handle assembly respectively in a front exploded view and a rear exploded view of the door handle assembly 110. As shown in FIGS. 2A and 2B, in addition to the handle seat 112 and the handle 111, the door handle assembly 110 further includes the driving device 113, a handle shaft 118, a transmission device (which includes a transmission member 126 and an X-shaped hinge structure 129), a lock cylinder 116, an unlocking structure 125, a door lock connection structure 115, and a push-push structure 120.

The driving device 113 is, for example, a motor or an actuator including a motor. The handle shaft 118 rotates under the drive of the driving device 113. One end of the handle shaft 118 is fixedly connected to an output end 119 of the driving device 113. The other end of the handle shaft 118 is fixedly connected to the transmission device. The transmission device (which includes the transmission member 126 and the X-shaped hinge structure 129) connects the handle shaft 118 to the handle 111 and the handle seat 112, such that the handle 111 can be driven by the handle shaft 118 to move between the retracted position and the deployed position, and the transmission device can move to drive the handle shaft 118 to rotate when the operator operates the handle 111, thereby driving the output end 119 of the driving device 113 to rotate. The X-shaped hinge structure 129 of the transmission device is connected to the handle 111 and the handle seat 112 and configured to rotate about its rotation axis 130 to enable the handle 111 to move relative to the handle seat 112 to be deployed or retracted. The transmission member 126 of the transmission device connects the handle shaft 118 to the X-shaped hinge structure 129 such that the X-shaped hinge structure 129, under the drive of the driving device 113, can be driven by the handle shaft 118 to rotate, and the X-shaped hinge structure 129 rotates to drive the handle shaft 118 to rotate when the operator operates the handle 111, thereby driving the output end 119 of the driving device 113 to rotate.

As shown in FIGS. 2A and 2B, the handle seat 112 includes an accommodating cavity 156, and the handle 111 can be disposed in the accommodating cavity 156. A slot 144 is provided in a side wall of the handle 111. A through hole 154 is provided in a corresponding side wall of the handle seat 112. The handle 111 includes an accommodating cavity 157, which is formed in a portion of the handle 111 other than the grip 117. The transmission member 126 and the X-shaped hinge structure 129 of the transmission device can be disposed in the accommodating cavity 157. When the handle 111 is disposed in the accommodating cavity 156 of the handle seat 112, and the transmission member 126 and the X-shaped hinge structure 129 are disposed in the accommodating cavity 157, one end 127 of the transmission member 126 passes through the slot 144 of the handle 111 and the through hole 154 of the handle seat 112 in sequence and extends to the outside of the handle seat 112, and is thus fixedly connected to the other end of the handle shaft 118.

The X-shaped hinge structure 129 includes a first push rod 139 and a second push rod 140. The first push rod 139 and the second push rod 140 rotate about the rotation axis 130 at an intersection. The first push rod 139 includes a first end 131 and a second end 132. The first end 131 is slidably connected to the handle seat 112, and the second end 132 is pivotably connected to the handle 111. The second push rod 140 includes a third end 133 and a fourth end 134. The third end 133 is slidably connected to the handle 111, and the fourth end 134 is pivotally connected to the handle seat 112. In the accommodating cavity 157 of the handle 111, the second push rod 140 is closer to the side wall of the handle 111 provided with the slot 144 than the first push rod 139. The other end 128 of the transmission member 126 is slidably connected to the second push rod 140, and the end 127 of the transmission member 126 is fixedly connected to the handle shaft 118. The second push rod 140 includes a third connection groove 148. The transmission member 126 is provided with a third connection pin 153 at the end 128 thereof. The third connection pin 153 is configured to slide within the third connection groove 148. In an embodiment, as shown in a partial enlarged view of FIG. 2B (which shows a partial structure of the second push rod 140 from another perspective), an accommodating cavity 158 is formed in the second push rod 140. The accommodating cavity 158 extends in an extension direction of the second push rod 140 and is configured to accommodate at least a portion of the transmission member 126, which includes the end 128 of the transmission member 126. The accommodating cavity 158 is in communication with the third connection groove 148. The third connection groove 148 may be two grooves positioned opposite each other. The end 128 of the transmission member 126 is movable in the accommodating cavity 158 such that the third connection pin 153 on the end 128 slides within the third connection groove 148. This structure makes the door handle assembly 110 more compact. In other embodiments, the second push rod 140 may have no accommodating cavity 158, and the transmission member 126 is disposed outside the second push rod 140.

The handle seat 112 includes a first connection groove 152. The first push rod 139 of the X-shaped hinge structure 129 is provided with a first connection pin 135 at the first end 131 thereof. The first connection pin 135 is configured to slide within the first connection groove 152 of the handle seat 112. In an embodiment, the first connection groove 152 is formed in a protrusion 151 at the bottom of the handle seat 112. In other embodiments, the first connection groove 152 may be provided in other suitable structures. The handle 111 includes a second connection groove 141. The second push rod 140 of the X-shaped hinge structure 129 is provided with a second connection pin 137 at the third end 133 thereof. The second connection pin 137 is configured to slide within the second connection groove 141. In an embodiment, the second connection groove 141 is formed in a protrusion on an upper side portion of the handle 111. In other embodiments, the second connection groove 141 may be provided in other suitable structures. The handle 111 includes a first pivot hole 149. The first push rod 139 of the X-shaped hinge structure 129 is provided with a fourth connection pin 136 at the second end 132 thereof. The fourth connection pin 136 is configured to pivot in the first pivot hole 149 of the handle 111. In an embodiment, the first pivot hole 149 is formed in a protrusion on a lower side portion of the handle 111. In other embodiments, the first pivot hole 149 may be provided in other suitable structures. The handle seat 112 includes a second pivot hole 147. The second push rod 140 of the X-shaped hinge structure 129 is provided with a fifth connection pin 138 at the fourth end 134 thereof. The fifth connection pin 138 is configured to pivot in the second pivot hole 147 of the handle seat 112. In an embodiment, the second pivot hole 147 is formed in a protrusion 146 at the bottom of the handle seat 112. In other embodiments, the second pivot hole 147 may be provided in other suitable structures.

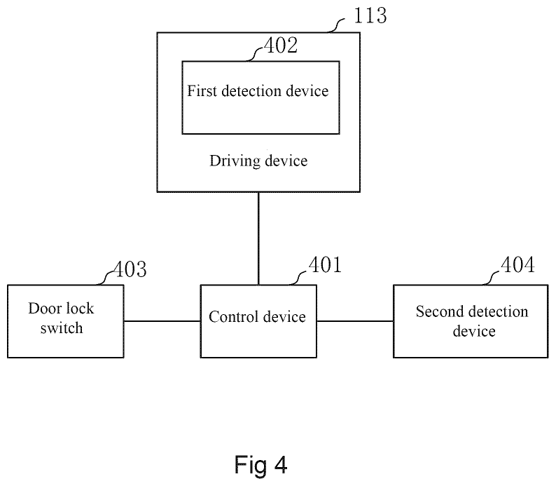

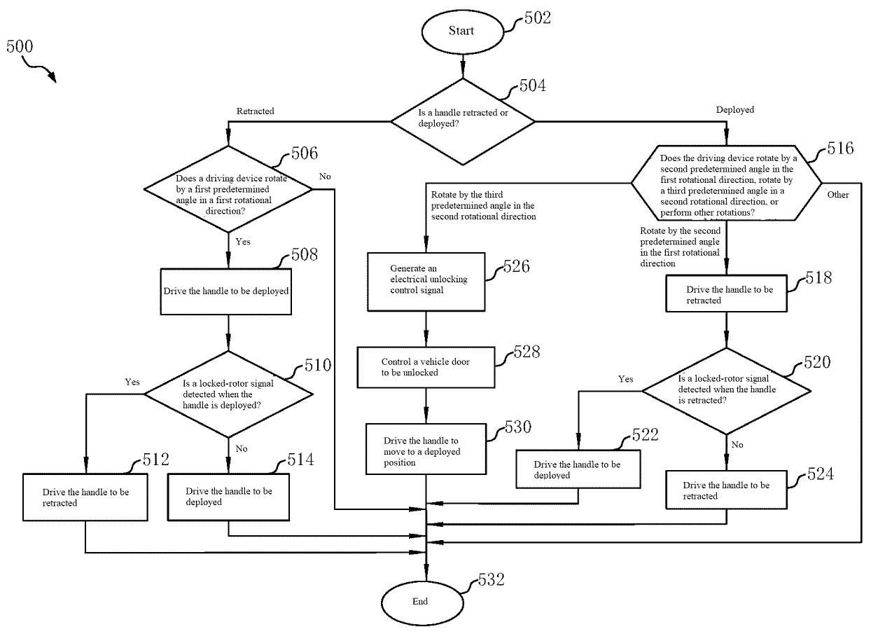

By providing the first connection groove 152, the second connection groove 141, the third connection groove 148, the first pivot hole 149 and the second pivot hole 147, the handle 111 is retracted or deployed relative to the handle seat 112 in a translational manner, that is, the surface of the handle 111 remains parallel to or coincident with an initial position as the handle is moved relative to the handle seat 112, and the rotational movement of the driving device 113 is converted into the translational movement of handle 111 relative to the handle seat 112. In an embodiment, the first connection groove 152 is a linear groove, the second connection groove 141 is a specific curved groove, and the third connection groove 148 is a specific curved groove. Moreover, by configuring the X-shaped hinge structure 129, the transmission member 126, the handle 111 and the handle seat 112 as described above, when the driving device 113 is activated to drive the handle shaft 118 to rotate, the transmission member 126 is driven by the handle shaft 118 to rotate, the second push rod 140 of the X-shaped hinge structure 129 is then driven by the transmission member 126 to rotate about the rotation axis 130, and the first push rod 139 of the X-shaped hinge structure 129 rotates about the rotation axis 130 accordingly, thereby allowing the handle 111 to move relative to the handle seat 112 to be retracted or deployed. In addition, when the operator operates the handle 111 to move relative to the handle seat 112, the X-shaped hinge structure 129 is correspondingly moved to drive the transmission member 126 to rotate by means of the second push rod 140, thereby driving the handle shaft 118 to rotate, and the driving device 113 (e.g., the output end 119 thereof) is ultimately driven to rotate. In other embodiments, the X-shaped hinge structure 129, the transmission member 126, the handle 111 and the handle seat 112 may have other suitable structures to implement the above functions. The structural configurations of the transmission member 126 and the X-shaped hinge structure 129 allow the linkage of the driving device 113 and the handle 111. In the present disclosure, when the operator operates the handle 111 to trigger the retraction or deployment of the handle or the unlocking of the vehicle door, the movement state or movement position of the handle 111 is determined according to the rotational movement of the driving device 113, the driving device 113 is then activated to move, so as to retract or deploy the handle 111 or to open a door lock switch 403 (see FIG. 4) for unlocking the vehicle door 101.

In the present disclosure, in addition to electrically unlocking the vehicle door described above, the vehicle door may also be unlocked mechanically, for example, by means of the movements of the unlocking structure 125 and the door lock connection structure 115. The unlocking structure 125 is fixedly connected to the door lock connection structure 115, which is connected to a cord (not shown) for unlocking the vehicle door 101. The unlocking structure 125 is driven to rotate by the X-shaped hinge structure 129 so as to drive the door lock connection structure 115 to rotate, and the door lock connection structure 115 then drives the cord to move so as to mechanically unlock the vehicle door 101. When the handle 111 is in the retracted position, the unlocking structure 125 is not engaged with the X-shaped hinge structure 129. When the handle 111 is in the deployed position, the unlocking structure 125 begins to be engaged with the second push rod 140 of the X-shaped hinge structure 129. When the operator pulls the handle 111 in the deployed position, the second push rod 140 rotates to drive the unlocking structure 125 to rotate, and the door lock connection structure 115 then rotates to drive the cord to move, thereby unlocking the vehicle door 101.

When the handle 111 experiences an electrical fault and cannot be deployed by means of electrical driving (e.g., by using the driving device 113), the handle 111 is mechanically pressed and pops out (deployed) by means of the push-push structure 120 in the present disclosure. The push-push structure 120 connects the handle 111 to the handle seat 112 such that pushing by the operator can move the handle 111 from the retracted position to an intermediately deployed position between the retracted position and the deployed position, or move the handle 111 from the intermediately deployed position to the retracted position. In an embodiment, the push-push structure 120 has a structure similar to a click structure of a ballpoint pen to implement a press-to-pop function. A base 142 is provided in the accommodating cavity 157 of the handle 111, and an elastic member (not shown), such as a spring, is provided in the base 142. One end of the push-push structure 120 is partially accommodated in the base 142 and abuts against the elastic member in the base 142, and the other end of the push-push structure 120 abuts against the bottom of the handle seat 112. In an embodiment, the base 142 is a cylindrical boss having an accommodating cavity for receiving the elastic member and the push-push structure 120. In other embodiments, other suitable push-push structures 120 may be used.

When the handle 111 is in the retracted position, the operator presses the handle 111 such that the push-push structure 120 is pressed inwardly, and the push-push structure 120 can then push the handle 111 outwardly (in a direction opposite to a pressing direction) relative to the handle seat 112 for a short stroke to expose the handle 111. In this case, the operator can pull the handle 111, so as to pull the handle 111 further outwardly to expose the grip 117. The operator holds the grip 117 to pull the handle 111 outwardly to the unlocked position, thereby driving the unlocking structure (e.g., pulling the cord) to unlock the vehicle door 101. The operator can then open the vehicle door 101. This emergency opening function of the vehicle door 101 is reusable. When the operator pushes the handle 111 in the unlocked position to the retracted position and further pushes the handle inwardly for a short stroke, the push-push structure 120 moves to reach an initial state so as to keep the handle 111 in the retracted position. Accordingly, when there is a subsequent requirement for emergency opening of the vehicle door 101, the push-push structure 120 can be operated again in the manner as describe above for the press-to-pop of the handle 111.

The present disclosure further provides another emergency opening function of the vehicle door 101, that is, opening the vehicle door 101 by using a mechanical key. As described above, the X-shaped hinge structure inside the handle is compact, so that an enough space is provided inside the handle to serve as a space for accommodating the lock cylinder. The handle 111 includes a removable handle cover 114. FIGS. 2A and 2B show the handle cover 114 removed from the handle 111. The handle 111 includes an engagement portion 143 configured to be engaged with a corresponding component (not shown) on the handle cover 114 to removably mount the handle cover 114 to the handle 111. A first accommodating portion 145 is provided in the accommodating cavity 156 of the handle seat 112. The first accommodating portion 145 is configured to accommodate the lock cylinder 116. The lock cylinder 116 can be opened by using the mechanical key to unlock the vehicle door 101. After the handle cover 114 is removed from the handle 111, the lock cylinder 116 becomes exposed for the operator to use. In operation, the operator can press the handle 111 in the retracted position, the push-push structure 120 then pushes the handle 111 outwardly (in the direction opposite to the pressing direction) for a short stroke, and the operator removes the handle cover 114, pushes the handle 111 back to the retracted position and inserts the mechanical key into the lock cylinder 116 to open the vehicle door 101.

FIG. 2C shows a perspective view, from a first perspective, of the unlocking structure 125 and the door lock connection structure 115 assembled together, and FIG. 2D shows a perspective view, from a second perspective, of the unlocking structure 125 and the door lock connection structure 115 of the door handle assembly, which are assembled together. As described previously, when the handle 111 is in the retracted position, the unlocking structure 125 is not engaged with the X-shaped hinge structure 129, in which case it is required to keep the unlocking structure 125 in the initial position to avoid looseness. The door lock connection structure 115 in the initial position remains fixed to the handle seat 112, such that the unlocking structure 125 remains in the initial position without becoming loose when not engaged with the X-shaped hinge structure 129.

As shown in FIGS. 2C and 2D and FIGS. 1B and 1C, the unlocking structure 125 includes a main body 123 and an engagement portion 124. The engagement portion 124 can be engaged with the X-shaped hinge structure 129. The main body 123 is substantially cylindrical. The unlocking structure 125 can rotate about a central axis of the main body 123. The engagement portion 124 extends from one end of the main body 123. The other end of the main body 123 is fixedly connected to the door lock connection structure 115. According to the lever principle, the distance between the end 121 of the engagement portion 124 engaged with the X-shaped hinge structure 129 and the central axis of the main body 123 is greater than the radius of the main body 123, for example, approximately twice the radius, such that a smaller force is applied to the end 121 to drive the unlocking structure 125 to rotate, so as to unlock the vehicle door.

The door lock connection structure 115 includes a main body 159 and a retaining portion. The retaining portion enables the door lock connection structure 115 in the initial position to remain fixed, for example, in a biased manner, to the handle seat 112. The main body 159 is substantially cylindrical. The door lock connection structure 115 can rotate about a central axis of the main body 159. One end of the main body 159 is fixedly connected to the other end of the main body 123 of the unlocking structure 125. For example, a connection between the main body 159 and the main body 123 is provided with matching tooth structures 122A, 122B arranged circumferentially, such that the unlocking structure 125 during rotation can drive the door lock connection structure 115 to rotate. For example, as shown in FIGS. 2C and 2D and FIGS. 1B and 1C, the retaining portion of the door lock connection structure 115 includes a torsion spring 160 and a protrusion 161. The protrusion 161 extends radially from a side wall of the main body 159. The torsion spring 160 is arranged around the main body 159, one end 165 of the torsion spring 160 abuts against the protrusion 161, and the other end 166 of the torsion spring 160 abuts against a protrusion 163 on the handle seat 112, such that the main body 159 of the door lock connection structure 115 in the initial position remains fixed to the handle seat 112, that is, the unlocking structure 125 remains in the initial position without becoming loose. For example, the end 165 of the torsion spring 160 is accommodated in a recessed portion 162 of the protrusion 161, and the end 166 of the torsion spring 160 is accommodated in a recessed portion 164 of the protrusion 163. The protrusion 163 is disposed on an outer shell of the handle seat 112. In the initial position, the torsion spring 160 is biased, for example, pressed, to retain the main body 159 of the door lock connection structure 115 on the handle seat 112 in a biased manner. The bias force generated by this bias is relatively small, such that when unlocking is required, the operator can easily rotate the unlocking structure 125 by pulling the handle 111, so as to unlock the vehicle door 101. When the operator pulls the handle 111 in the deployed position, the second push rod 140 of the X-shaped hinge structure 129 rotates to drive the unlocking structure 125 to rotate (see the counterclockwise direction shown in FIG. 1C and FIGS. 2C and 2D), and the door lock connection structure 115 then rotates against the restoring force of the torsion spring to move the cord, thereby unlocking the vehicle door 101. By means of the cooperation of the unlocking structure 125 and the door lock connection structure 115 with the X-shaped hinge structure 129, the present disclosure enables the handle 111 to be operated to mechanically unlock the vehicle door 101. The unlocking structure 125 and the door lock connection structure 115 may be integrally formed. For example, the main body 123 and the main body 159 may be a one-piece component. In other embodiments, the door handle assembly 110 includes other suitable structures to implement the above function.

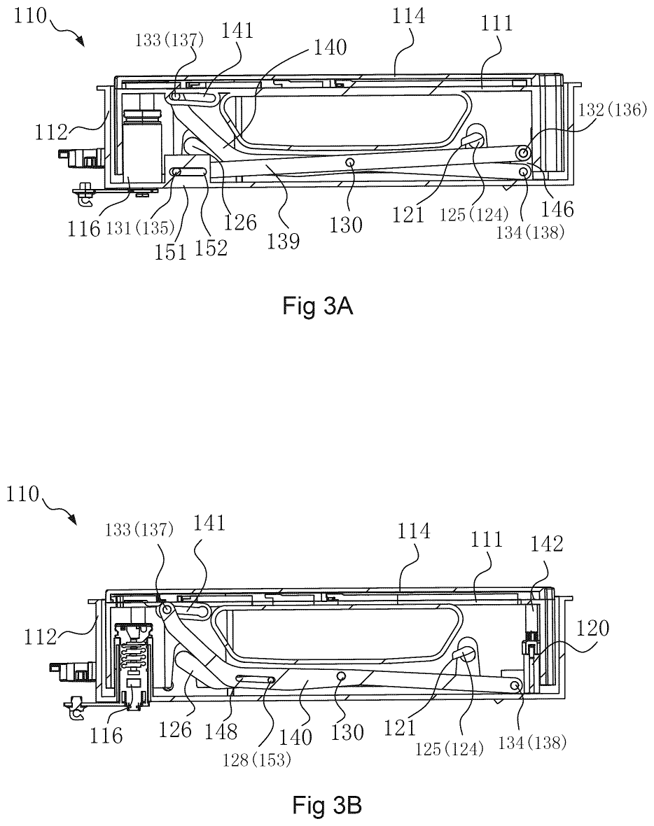

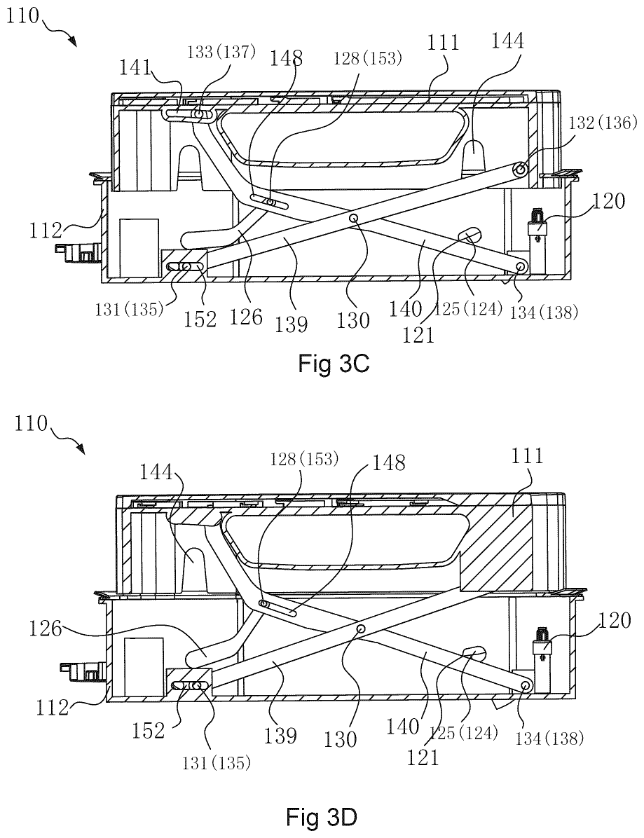

FIGS. 3A-3D show the assembly relationship of the components of the door handle assembly 110 at each position. FIG. 3A is a cross-sectional view, taken along a first section line, of the door handle assembly 110 shown in FIG. 1D, with the handle 111 in the retracted position; FIG. 3B is a cross-sectional view, taken along a second section line, of the door handle assembly 110 shown in FIG. 1D, with the handle 111 in the retracted position; FIG. 3C is a cross-sectional view of the door handle assembly 110 shown in FIG. 1E, with the handle 111 in the deployed position; and FIG. 3D is a cross-sectional view of the door handle assembly 110 shown in FIG. 1F, with the handle 111 in the unlocked position.

As shown in FIGS. 3A and 3B, when the handle 111 is in the retracted position, the first connection pin 135 at the first end 131 of the first push rod 139 is located on a left side of the first connection groove 152 in the protrusion 151 of the handle seat 112, and the fourth connection pin 136 at the second end 132 of the first push rod 139 is pivotable in the first pivot hole 149 (not shown) of the handle 111. The second connection pin 137 at the third end 133 of the second push rod 140 is located on a left side of the second connection groove 141 on the upper side portion of the handle 111, and the fifth connection pin 138 at the fourth end 134 of the second push rod 140 is pivotable in the second pivot hole 147 (not shown) in the protrusion 146 of the handle seat 112. The third connection pin 153 at the end 128 of the transmission member 126 is located on a right side of the third connection groove 148 of the second push rod 140. The unlocking structure 125 is located above the second push rod 140, but is not engaged with the second push rod 140. An upper end of the push-push structure 120 is accommodated in and abuts against the base 142 of the handle 111.

When the driving device 113 drives the handle 111 to move from the retracted position of FIGS. 3A and 3B to the deployed position of FIG. 3C, the end 128 of the transmission member 126 is driven by the driving device 113 to rotate counterclockwise. The third connection pin 153 at the end 128 of the transmission member 126 then drives the second push rod 140 to pivot around the fifth connection pin 138, and the second connection pin 137 of the second push rod 140 moves toward a right side of the second connection groove 141 of the handle 111. Correspondingly, the first push rod 139 is pivoted around the fourth connection pin 136, and the first connection pin 135 of the first push rod 139 moves toward the right side of the first connection groove 152 of the handle seat 112. When the operator moves the handle 111 from the retracted position of FIGS. 3A and 3B to the deployed position of FIG. 3C, the handle 111 is deployed outwardly to drive the first push rod 139 and the second push rod 140 to move as described above, and the second push rod 140 drives the end 128 of the transmission member 126 to rotate counterclockwise by means of the third connection groove 148. When the handle 111 is moved from the deployed position of FIG. 3C to the retracted position of FIGS. 3A and 3B, the components of the door handle assembly 110 perform operations opposite to the operations described above.

As shown in FIG. 3C, when the handle 111 is in the deployed position, the third connection pin 153 at the end 128 of the transmission member 126 is located substantially in the middle of the third connection groove 148 of the second push rod 140, the first connection pin 135 of the first push rod 139 is located substantially in the middle of the first connection groove 152 of the handle seat 112, and the second connection pin 137 of the second push rod 140 is located on the right side of the second connection groove 141 of the handle 111. The end 121 of the unlocking structure 125 begins to be engaged with the second push rod 140. The upper end of the push-push structure 120 is separated from the base 142 of the handle 111.

When the operator moves the handle 111 from the deployed position of FIG. 3C to the unlocked position of FIG. 3D, the handle 111 is further deployed outwardly to drive the first push rod 139 to pivot around the fourth connection pin 136, the first connection pin 135 of the first push rod 139 moves further toward the right side of the first connection groove 152 of the handle seat 112 and drives the second push rod 140 to pivot around the fifth connection pin 138, the second connection pin 137 of the second push rod 140 moves further toward the right side of the second connection groove 141 of the handle 111, and the second push rod 140 drives the end 128 of the transmission member 126 to further rotate counterclockwise by means of the third connection groove 148. The unlocking structure 125 is driven by the second push rod 140 to rotate clockwise, so as to unlock the vehicle door 101 by means of the door lock connection structure 115.

As shown in FIG. 3D, when the handle 111 is in the unlocked position, the third connection pin 153 at the end 128 of the transmission member 126 is located on a left side of the third connection groove 148 of the second push rod 140, the first connection pin 135 of the first push rod 139 is located on a right side of the first connection groove 152 of the handle seat 112, and the second connection pin 137 of the second push rod 140 is located on the right side of the second connection groove 141 of the handle 111. The unlocking structure 125 (e.g., the end 121 thereof) is engaged with the second push rod 140 and rotates to the unlocked position, in which case the vehicle door 101 is unlocked. The upper end of the push-push structure 120 is still separated from the base 142 of the handle 111.

Although the specific rotational directions are described above, such as clockwise and counterclockwise, other suitable structures of the X-shaped hinge structure 129 and the transmission member 126 may cause relevant components to rotate in other rotational directions so as to perform the above functions.

FIG. 4 is a block diagram of elements of the door handle assembly 110 in communication with a control device 401 according to an embodiment of the present disclosure. As shown in FIG. 4, the driving device 113 of the door handle assembly 110 includes a first detection device 402. The door handle assembly 110 further includes the control device 401, the door lock switch 403 and a second detection device 404. The driving device 113, the door lock switch 403 and the second detection device 404 are all communicatively connected to the control device 401.

The control device 401 controls the driving device 113 to rotate in either a first rotational direction or a second rotational direction, and thus drives the handle 111 to be retracted or deployed. Furthermore, the control device 401 can monitor the driving device 113, receive the signals indicative of a direction and angle of rotation of the output end 119 of the driving device 113, obtain the positions of the driving device 113 and the handle 111 based on the signals indicative of the direction and angle of rotation, and control the driving device 113 as required to control the movement of the handle 111. For example, when the handle 111 is in the retracted position, the driving device 113 is in the initial position, and the initial angle of the output end 119 thereof is 0 degree; and when the handle 111 is moved from the retracted position to the deployed position, the driving device 113 is in the deployed position, and the angle of rotation of the output end 119 thereof is, for example, 60 degrees. When the handle 111 is moved from the retracted position to the deployment trigger position, the driving device 113 (e.g., the output end 119 thereof) rotates relative to the initial position by a first predetermined angle (e.g., greater than 1 degree) in the first rotational direction; when the handle 111 is moved from the deployed position to the retraction trigger position, the driving device 113 (e.g., the output end 119 thereof) rotates relative to the deployed position by a second predetermined angle (e.g., greater than 2 degrees) in the first rotational direction; and when the handle 111 is moved from the deployed position to the unlocked position, the driving device 113 (e.g., the output end 119 thereof) rotates relative to the deployed position by a third predetermined angle (e.g., greater than 5 degrees) in the second rotational direction.

To this end, the driving device 113 is provided with the first detection device 402 for detecting or obtaining the angle of rotation of the output end 119 of the driving device 113. In some embodiments, the first detection device 402, for example, includes a plurality of position sensors that can detect whether the output end 119 of the driving device 113 reaches the retracted position, the deployed position, the unlocked position, the retraction trigger position, the deployment trigger position, etc., and send detected signals to the control device 401. In some embodiments, the first detection device 402 is, for example, an encoder, and the angle of rotation of the output end 119 of the driving device 113 can be obtained by means of a pulse signal output by the encoder.

In some embodiments, for the direction of rotation of the output end 119 of the driving device 113, if the output end 119 of the driving device 113 is controlled by the control device 401 to rotate, the control device 401 can obtain the information about the direction of rotation of the output end 119 of the driving device 113 by controlling the direction of a current. If the output end 119 of the driving device 113 is rotated in response to the handle shaft 118 being rotated by a preset angle when the operator operates the handle 111, the driving device 113 generates a reverse excitation current, the control device 401 can obtain the information about the direction of rotation of the output end 119 of the driving device 113 by means of the direction of the reverse excitation current. For this purpose, the door handle assembly 110 is further provided with the second detection device 404. The second detection device 404 can detect the reverse excitation current generated by the driving device 113 and send a signal to the control device 401, such that the control device 401 obtains the information about the direction of rotation of the output end 119 of the driving device 113.

Moreover, the second detection device 404 can also detect the current generated by the driving device 113 to obtain a locked-rotor signal of the driving device 113. For example, the locked-rotor signal of the driving device 113 may be obtained by detecting whether the current of the driving device 113 exceeds a certain threshold value for a certain period of time. The control device 401 obtains the locked-rotor signal of the driving device 113 from the second detection device 404 to allow reverse rotation of the driving device 113, thereby preventing the driving device from still rotating in its original direction and pinching an object (such as a human hand) in the event that the handle is obstructed by the object. Therefore, the door handle assembly 110 according to the present disclosure has an anti-pinch function.

Moreover, the control device 401 can send an unlocking control signal to the door lock switch 403 based on the received signals indicative of the angle and direction of rotation of the output end 119 of the driving device 113 to open the door lock switch 403, such that the vehicle door 101 is unlocked.

FIG. 5 is a flow chart of a method 500 for operating a door handle assembly 110 according to an embodiment of the present disclosure. As shown in FIG. 5, in step 502, the method for operating a door handle assembly 110 begins to be performed, and then step 502 proceeds to step 504. In an embodiment, the method for controlling the operation of a door handle assembly 110 by the control device 401 begins to be performed.

In step 504, it is determined whether a handle 111 of the door handle assembly 110 is in a retracted position or a deployed position. In an embodiment, the control device 401 determines whether the handle 111 is in the retracted position or the deployed position, for example, based on signals indicative of an angle and direction of rotation of an output end 119 of a driving device 113. When it is determined that the handle 111 is in the retracted position, step 504 proceeds to step 506. In step 506, the control device 401 determines whether an operator's operation on the handle 111 causes the output end 119 of the driving device 113 to rotate by a first predetermined angle in a first rotational direction. If the output end 119 of the driving device 113 is rotated by the first predetermined angle (e.g. greater than 1 degree) in the first rotational direction (e.g., the clockwise direction as shown in FIGS. 3A and 3B), it is indicated that the operator has pressed the handle 111 to trigger the deployment of the handle, and step 506 proceeds to step 508. In step 508, the control device 401 controls the rotation of the output end 119 of the driving device 113 in a second rotational direction (e.g., the counterclockwise direction shown in FIGS. 3A and 3B) to deploy the handle 111, and step 508 proceeds to step 510. In step 510, as the driving device 113 drives the handle 111 to move from the retracted position to the deployed position, the control device 401 determines whether the driving device 113 generates a locked-rotor signal. When the driving device 113 generates the locked-rotor signal, it is indicated that the operation of deploying the handle 111 may bump against an object (e.g., the human hand), and step 510 proceeds to step 512. When the driving device 113 does not generate the locked-rotor signal, step 510 proceeds to step 514. In step 512, the control device 401 controls the rotation of the driving device 113 in the first rotational direction opposite to the second rotational direction to retract the handle 111, thereby preventing the operation of deploying the handle 111 from bumping against the object (e.g., the human hand). Then, step 512 proceeds to step 532, ending this operation of controlling the handle 111 by the control device 401. In step 514, the control device 401 controls the driving device 113 to continue to rotate in the second rotational direction so as to deploy the handle 111. Then, step 514 proceeds to step 532, ending this operation of controlling the handle 111 by the control device 401.

In step 504, when the control device 401 determines that the handle 111 is in the deployed position, step 504 proceeds to step 516. In step 516, the control device 401 determines whether the operator's operation on the handle 111 causes the output end 119 of the driving device 113 to rotate by a second predetermined angle in the first rotational direction, rotate by a third predetermined angle in the second rotational direction, or perform other rotations. If the output end 119 of the driving device 113 is rotated by the second predetermined angle (e.g., greater than 2 degrees) in the first rotational direction (e.g., the clockwise direction as shown in FIG. 3C), it is indicated that the operator has pressed the handle 111 to trigger the retraction of the handle, and step 516 proceeds to step 518. In step 518, the control device 401 controls the rotation of the output end 119 of the driving device 113 in the first rotational direction to retract the handle 111, and step 518 proceeds to step 520. In step 520, as the driving device 113 drives the handle 111 to move from the deployed position to the retracted position, the control device 401 determines whether the driving device 113 generates a locked-rotor signal. When the driving device 113 generates the locked-rotor signal, it is indicated that the operation of retracting the handle 111 may pinch an object (e.g., the human hand), and step 520 proceeds to step 522. When the driving device 113 does not generate the locked-rotor signal, step 520 proceeds to step 524. In step 522, the control device 401 controls the rotation of the output end 119 of the driving device 113 in the second rotational direction (e.g., the counterclockwise direction shown in FIG. 3C) opposite to the first rotational direction to deploy the handle 111, thereby preventing the operation of retracting the handle 111 from pinching the object (e.g., the human hand). Then, step 522 proceeds to step 532, ending this operation of controlling the handle 111 by the control device 401. In step 524, the control device 401 controls the output end 119 of the driving device 113 to continue to rotate in the first rotational direction so as to continue to retract the handle 111. Then, step 524 proceeds to step 532, ending this operation of controlling the handle 111 by the control device 401.

In step 516, when it is determined that the output end 119 of the driving device 113 is rotated by the third predetermined angle (e.g., greater than 5 degrees) in the second rotational direction, it is indicated that the operator has pulled the handle 111 in the deployed position to trigger the electrical unlocking, and step 516 proceeds to step 526. In step 526, the control device 401 generates an electrical unlocking control signal, and then step 526 proceeds to step 528. In step 528, the control device 401 outputs the electrical unlocking control signal to the door lock switch 403 so as to control the opening of the door lock switch 403 such that the vehicle door 101 is unlocked, and then step 528 proceeds to step 530. In step 530, the control device 401 controls the rotation of the output end 119 of the driving device 113 in the first rotational direction (the clockwise direction shown in FIG. 3D), so as to move the handle 111 from the unlocked position to the deployed position. After the vehicle door 101 is unlocked, the operator can pull the handle 111 in the deployed position to open the vehicle door 101. Then, step 530 proceeds to step 532, ending this operation of controlling the handle 111 by the control device 401.

In step 516, when it is determined that the output end 119 of the driving device 113 performs other rotations, step 516 proceeds to step 532, ending the operation of controlling the handle 111 by the control device 401.

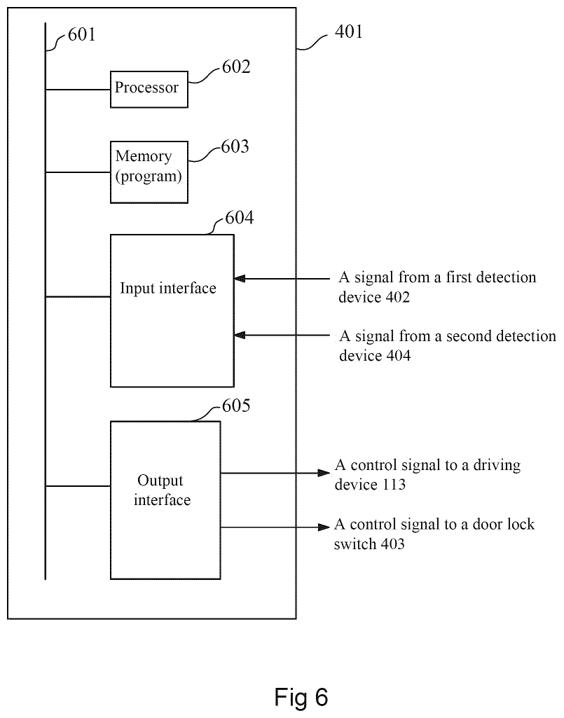

FIG. 6 is a block diagram of an embodiment of the control device 401 shown in FIG. 4. As shown in FIG. 6, the control device 401 includes a bus 601, a processor 602, a memory 603, an input interface 604, and an output interface 605. The processor 602, the memory 603, the input interface 604 and the output interface 605 are connected to the bus 601. The processor 602 can read a program (or an instruction) from the memory 603 and execute the program (or the instruction) to perform processing on data. The processor 602 can further write data or the program (or the instruction) into the memory 603. The memory 603 can store the program (the instruction) or the data. By executing the instruction in the memory 603, the processor 602 can control the memory 603, the input interface 604 and the output interface 605.

The input interface 604 is configured to receive data for the angle of rotation of the output end 119 of the driving device 113 obtained by the first detection device 402, and for the current generated by the driving device 113 and obtained by the second detection device 404. The input interface 604 is further configured to convert the received data for parameters into data recognizable by the processor 602 and output the data to the processor 602.

The processor 602 is configured to process (e.g., compute) the received data to generate control signals. In an embodiment, the processor 602 processes the obtained data for the angle of rotation of the output end 119 of the driving device 113 and on the current generated by the driving device 113 to generate the control signals, so as to execute the steps in the method 500 described above.

The output interface 605 is configured to receive the control signals from the processor 602, convert the control signals into the signals of the driving device 113 and send the control signals to the driving device 113, so as to control the operation of the driving device 113 to deploy or retract the handle 111 or to control the operation of the door lock switch 403.

According to an aspect of the present disclosure, the door handle assembly of the present disclosure is provided with an X-shaped hinge structure and a transmission member. The transmission member has one end fixedly connected to the driving device and the other end movably connected to the X-shaped hinge structure, and the X-shaped hinge structure is movably connected to the handle and the handle seat, such that the rotational movement of the driving device can be converted into the movement of the X-shaped hinge structure and then into the translational movement of the handle relative to the handle seat. Therefore, the present disclosure can achieve the translational movement for the deployment, retraction and unlocking of the handle.

According to another aspect of the present disclosure, the X-shaped hinge structure and the transmission member of the present disclosure also structurally enable the operator to convert the operation on the handle into the rotational movement of the driving device, that is, allowing the linkage of the handle and the driving device. In the present disclosure, in response to the rotation of the driving device by the predetermined angle in the predetermined direction when the operator operates the handle, the driving device is activated to deploy or retract the handle or the door lock switch is operated to unlock the vehicle door. Therefore, the door handle assembly of the present disclosure does not need to be provided with additional electronic elements, such as capacitors, microswitches or other sensors, for sensing the operator's action of deploying or retracting the handle or unlocking the vehicle door. Therefore, the door handle assembly of the present disclosure allows for the deployment and retraction of the flush door handle and the unlocking of the vehicle door with fewer elements and a more concise appearance.

According to another aspect of the present disclosure, the present disclosure is further provided with an unlocking structure configured such that when the operator pulls the handle in the deployed position, the X-shaped hinge structure is rotated to drive the movement of the unlocking structure, so as to mechanically unlock the vehicle door. In addition, as described previously, the present disclosure may also open the door lock switch to electronically unlock the vehicle door in response to the rotation of the driving device by the predetermined angle in the predetermined direction when the operator operates the handle. Therefore, the present disclosure can adapt to mechanical and electronic door locks on the same platform, achieving mechanical and electronic unlocking of the vehicle door.

According to another aspect of the present disclosure, the present disclosure further realizes the emergency opening function of the vehicle door by means of the push-push structure.

According to another aspect of the present disclosure, in the door handle assembly according to the present disclosure, the structure of the transmission device between the handle and the driving device is simplified, thus enabling the deployment and retraction of the flush door handle and the unlocking of the vehicle door with a simpler mechanical structure.

Although the present disclosure is described with reference to the examples of the embodiments, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

1. A door handle assembly for a vehicle door, the vehicle door having a door surface, the door handle assembly comprising:
a handle seat;
a handle having a retracted position and a deployed position, wherein the handle is flush with the door surface when the handle is in the retracted position, and the handle protrudes outwardly relative to the door surface when the handle is in the deployed position;
a driving device;
a handle shaft being configured to rotate when driven by the driving device; and
a transmission device,
wherein the transmission device connects the handle shaft to the handle and the handle seat, such that the handle can be driven by the handle shaft to move between the retracted position and the deployed position relative to the handle seat, and the transmission device moves to rotate the handle shaft when an operator operates the handle; and
the driving device is configured such that when the handle is in the retracted position or in the deployed position, the driving device is activated in response to the rotation of the handle shaft as the operator operates the handle, so as to deploy or retract the handle.

2. The door handle assembly according to claim 1, wherein the handle shaft is fixedly connected to an output end of the driving device.

3. The door handle assembly according to claim 1, wherein the transmission device comprises:
an X-shaped hinge structure being connected to the handle and the handle seat and configured to rotate about its rotation axis to enable the handle to move relative to the handle seat to be deployed or retracted; and
a transmission member connecting the handle shaft to the X-shaped hinge structure such that the X-shaped hinge structure, under the drive of the driving device, can be driven by the handle shaft to rotate, and the X-shaped hinge structure rotates to drive the handle shaft to rotate when the operator operates the handle.

4. The door handle assembly according to claim 3, wherein the X-shaped hinge structure comprises:
a first push rod comprising a first end and a second end, the first end being slidably connected to the handle seat and the second end being pivotably connected to the handle; and
a second push rod comprising a third end and a fourth end, the third end being slidably connected to the handle and the fourth end being pivotably connected to the handle seat, the first push rod and the second push rod rotating about the rotation axis at an intersection,
wherein one end of the transmission member is slidably connected to the second push rod, and the other end of the transmission member is fixedly connected to the handle shaft.

5. The door handle assembly according to claim 4,
wherein the handle seat comprises a first connection groove, and the first push rod is provided with a first connection pin at the first end thereof, the first connection pin is configured to slide within the first connection groove;
wherein the handle comprises a second connection groove, and the second push rod is provided with a second connection pin at the third end thereof, the second connection pin is configured to slide within the second connection groove; and
wherein the second push rod comprises a third connection groove, and the transmission member is provided with a third connection pin, the third connection pin is configured to slide within the third connection groove.

6. The door handle assembly according to claim 1, further comprising:
an unlocking structure being configured to be driven by the X-shaped hinge structure to rotate so as to unlock the vehicle door.

7. The door handle assembly according to claim 1, further comprising:
a push-push structure connecting the handle to the handle seat such that pushing by the operator can move the handle from the retracted position to an intermediately deployed position between the retracted position and the deployed position, or move the handle from the intermediately deployed position to the retracted position.

8. The door handle assembly according to claim 1, wherein the handle comprises a removable handle cover, and a lock cylinder of the vehicle door is accommodated in the handle, the handle cover is configured to expose the lock cylinder when it is removed.

9. The door handle assembly according to claim 2, further comprising:
a detection device being configured to detect an angle and direction of rotation of the output end of the driving device for activation of the driving device or unlocking of the vehicle door.

10. The door handle assembly according to claim 9, further comprising:
a control device being communicatively connected to the detection device and the driving device,
wherein the control device is configured to control the rotation of the driving device in a first rotational direction to deploy the handle, or in a second rotational direction opposite to the first rotational direction to retract the handle, or to control the unlocking of the vehicle door, based on the detected angle and direction of rotation of the driving device.

11. A method for operating a door handle assembly mounted in a vehicle door, the method comprising the following steps:
S1: detecting whether a handle of the door handle assembly is in a retracted position or a deployed position;
S2: detecting an angle and direction of rotation of an output end of a driving device when an operator operates the handle;
S3.1: activating the driving device to control the movement of the handle to the deployed position when it is detected that the handle is in the retracted position and the output end of the driving device rotates by a first predetermined angle in a first rotational direction;
S3.2: activating the driving device to control the movement of the handle to the retracted position when it is detected that the handle is in the deployed position and the output end of the driving device rotates by a second predetermined angle in the first rotational direction; and
S3.3: controlling the unlocking of the vehicle door and activating the driving device to control the return of the handle to the deployed position when it is detected that the handle is in the deployed position and the output end of the driving device rotates by a third predetermined angle in a second rotational direction opposite to the first rotational direction.

12. The method according to claim 11,
wherein in the step S3.1, if a locked-rotor signal of the driving device is detected, the driving device controls the return of the handle to the retracted position; and
wherein in the step S3.2, if the locked-rotor signal of the driving device is detected, the driving device controls the return of the handle to the deployed position.

13. The method according to claim 11, wherein the driving device rotates in the first rotational direction to retract the handle and rotates in the second rotational direction to deploy the handle.

14. A door handle assembly for a vehicle door, the vehicle door having a door surface, the door handle assembly comprising:
a handle seat;
a handle having a retracted position and a deployed position, wherein the handle is flush with the door surface when the handle is in the retracted position, and the handle protrudes outwardly relative to the door surface when the handle is in the deployed position;
a handle shaft being configured to rotate under the drive of the driving device;
an X-shaped hinge structure being connected to the handle and the handle seat and configured to rotate about its rotation axis to enable the handle to move relative to the handle seat to be deployed or retracted; and
a transmission member connecting the handle shaft to the X-shaped hinge structure such that the X-shaped hinge structure, under the drive of the driving device, can be driven by the handle shaft to rotate, and the X-shaped hinge structure rotates to drive the handle shaft to rotate when the operator operates the handle.

15. The door handle assembly according to claim 14, wherein the X-shaped hinge structure comprises:
a first push rod comprising a first end and a second end, the first end being slidably connected to the handle seat and the second end being pivotably connected to the handle; and
a second push rod comprising a third end and a fourth end, the third end being slidably connected to the handle and the fourth end being pivotably connected to the handle seat, the first push rod and the second push rod rotating about the rotation axis at an intersection,
wherein one end of the transmission member is slidably connected to the second push rod, and the other end of the transmission member is fixedly connected to the handle shaft.

16. The door handle assembly according to claim 15,
wherein the handle seat comprises a first connection groove, and the first push rod is provided with a first connection pin at the first end thereof, the first connection pin is configured to slide within the first connection groove;
wherein the handle comprises a second connection groove, and the second push rod is provided with a second connection pin at the third end thereof, the second connection pin is configured to slide within the second connection groove; and
wherein the second push rod comprises a third connection groove, and the transmission member is provided with a third connection pin, the third connection pin is configured to slide within the third connection groove.

17. The door handle assembly according to claim 14, further comprising:
an unlocking structure being configured to be driven by the X-shaped hinge structure to rotate so as to unlock the vehicle door.

18. The door handle assembly according to claim 14, further comprising:
a push-push structure connecting the handle to the handle seat such that pushing by the operator can move the handle from the retracted position to an intermediately deployed position between the retracted position and the deployed position, or move the handle from the intermediately deployed position to the retracted position.

19. The door handle assembly according to claim 14, wherein the handle comprises a removable handle cover, and a lock cylinder of the vehicle door is accommodated in the handle, the handle cover is configured to expose the lock cylinder when it is removed.

20. The door handle assembly according to claim 14, wherein the handle shaft is fixedly connected to an output end of the driving device.
